(19) United States
(12) Patent Application Publication
(10) Pub. No.: US 2007/0032150 A1
(43) Pub. Date: Feb. 8, 2007

(54) Architectural fabric

(75) Inventors: Patrick Hermans, Vichte (BE); Robert Off, Bernburg (DE)

Correspondence Address: FOLEY AND LARDNER LLP;SUITE 500, 3000 K STREET NW, WASHINGTON, DC, 20007, US

(73) Assignee: N.V. BEKAERT S.A.

(21) Appl. No.: 10/572,481

(22) PCT Filed: Sep. 7, 2004
(86) PCT No.: PCT/EP04/52072

§ 371 Date: Mar. 17, 2006

(30) Foreign Application Priority Data
Sep. 19, 2003 (EP) 03103455.6

(51) Int. Cl. B32B 27/12; D03D 15/00; B32B 5/22; B32B 27/04

(52) U.S. Cl. 442/38; 442/43; 442/76; 442/6

(57) ABSTRACT

An architectural fabric is claimed where the tension members are strips. These strips comprise a tension member and a polymer matrix. The matrix is preferably of the thermoplastic type and is preferably chemically attached to the polymer used for the membrane. However, mechanical fastening of the strip to the membrane or a combination of chemical and mechanical fastening is not excluded. The advantages are that such a strip is better weather resistant, offers better strength to weight ratios and gives a larger contact surface to the membrane.

### FIELD OF THE INVENTION

The invention relates to architectural fabrics as used to protect and isolate large building infrastructures from climatic conditions. More specifically it relates to tensioned fabric structures such as air-supported structures, suspended structures and tensegrity structures.

### BACKGROUND OF THE INVENTION

Tensioned architectural fabric structures—be it air supported, suspended structures or tensegrity structures—are known as building elements notably for roof structures. These structures, mainly used to cover large surfaces without needing many intermediate support columns—such as sport stadiums—comprise sheet-like flexible materials that are attached to a grid of elongated tension members. The sheet-like flexible material is mostly in the form of a reinforced foil or canvas, called a membrane in what follows. The common feature of these structures is that only tensile forces occur on the membrane thus holding it tight at all times. These tensile forces are guided through the tension members towards suspension, attachment or anchoring points. The tensile forces can originate from gravity as for example in the case of suspended structures or can originate from an overpressure maintained inside the building infrastructure in case of air-supported structures. The design of the underlying grid pattern of the tension member is determined by the type of area to be covered. Popular are e.g. geodesic patterns that are particularly favoured because of their good stress distribution properties. An example of this can be found in U.S. Pat. No. 3,744,191. Besides geodesic structures other particular patterns exist for specific ground surfaces to be covered as e.g. described in U.S. Pat. No. 3,835,599 for a rectangular base area or U.S. Pat. No. 5,343,658 for a triangular base area. The requirements that are put forward to the tension member can be enumerated as follows:
Req. 1. The tension member must be strong enough to hold the load exerted by not only the sheet-like flexible material, but also the weight of everything that can fall on the roof such as snow, rainwater;
Req. 2. The tension member must be sufficiently light as not to add additional weight that again adds to the load on the tension member;
Req. 3. The tension member should be sufficiently flexible in order to allow it to follow the shape of the membrane structure;
Req. 4. The tension member should keep its length under load and under all possible climatic circumstances;
Req. 5. The tension member must be easily attachable to the membrane;
Req. 6. The tension member should not loose its properties over time in severe weather circumstances;

Steel cables have been favoured for the implementations of these structures: they are reasonably strong (Req. 1), are light relative to their strength (Req. 2), are flexible enough (Req. 3), and do not show a large elongation or creep over time (Req.4). However, due to their round shape they are not easily attachable to the membrane (Req. 5). Most used are stitched fabric bands on top of the membrane forming a sleeve through which the cable is guided. The same way of working can be used at the edges of the membrane by folding back and stitching again forming a sleeve for the edge cables. Due to the wind, the steel cables tend to rub against the membrane. Over time the cord can even cut through the membrane, thus decreasing the lifetime of the architectural fabric.

Also steel cables tend to corrode contrary to Req. 5. Especially in a damp and wet atmosphere—possibly enhanced by the enclosure of the sleeve—even galvanised cords are ultimately prone to rusting.

### SUMMARY OF THE INVENTION

The inventors have found a way to eliminate the drawbacks of the prior art. More in particular they have invented an architectural fabric where the tension member is stronger, flexible, does not excessively stretch, is easy to apply to the membrane with a high contact surface and does withstand weather influences over an extended period of time.

The invention relates to the combination of features as described in claim 1. Specific features for preferred embodiments of the invention are set out in the dependent claims.

The envisaged architectural fabric is used for the covering of a building infrastructure. It may e.g. be used as an element of a roof. Or it can be used as an architectural fabric to isolate sidewalls from atmospheric influences. The architectural fabric is equally well usable as a suspended or as an air-supported structure. Air supported structures can be either supported by an overpressure inside the whole building or by formation of air inflated pockets, the grid forming the borders of the air pockets.

The architectural fabric comprises a membrane and a grid. The membrane comprises a base fabric (either woven or non-woven, the word combination ‘base fabric’ is used in order to discriminate with the overall invention which is called ‘architectural fabric’). The base fabric may be made from natural or manmade fibres. Manmade fibres such as glass fibre, polyamide, aromatic polyamides (aramid), high performance polyethylene, polyester, carbon fibres or the like are greatly preferred for their strength, their resistance to weather conditions and their durability. In case a woven fabric is used, the weave used can be any weave suited for the application such as a plain, rib, twill, panorama, atlas weave or the like. The membrane can further be treated to make it water impermeable. It can for example be laminated or impregnated with any one of the group of polyvinylchloride (PVC) or polyimide or polyurethane (PUR) or high density polyethylene (HD PE) or siloxanes or polytetrafluoroethylene (PTFE) or fluorinated ethylene propylene (FEP) or perfluoro-alkoxy (PFA) or ethylene-tetrafluoroethylene (ETFE) or any other polymer that is suitable to give the membrane the required properties.

In case no water impermeability is needed—e.g. when only shadowing is desired—the impregnation is not necessary.

The membrane can also exist solely out of an extruded polymer foil without need for a supporting base fabric. Any polymer that is suitable for this purpose can be used. Non-exhaustive examples are again PVC foils or ETFE. ETFE is preferred for e.g. green houses, swimming pools or zoos because of the very good translucence (more than 95% of the sunlight is transmitted), UV stability, strength combined with a low dead load, and resistance against acid or alkaline solutions. More than one membrane is possible. For example when the architectural fabric is of the air pocket type, at least two membranes are needed wherein between a gas overpressure is maintained. Even three membranes are possible as for example disclosed in U.S. Pat. No. 4,024,679.

In order to support the architectural fabric over large spans tension members are needed. These tension members are arranged according a certain pattern, dictated by the shape of the area to be covered, the strength and stretch of the membrane, the weight per surface area of the membrane, the strength and elongation of the tension member, the weigh per unit length of the tension member, the position of the poles and/or girders for supporting the architectural fabric or the position of the anchoring points in case an air supported structure is envisaged. The tension members arranged according this pre-calculated pattern thus form a grid.

The characteristic of the invention (claim 1) is that the tension members are provided in the form of a strip, said strip having a certain height and a certain width, and said height being less than half of the width. The cross section of this strip thus shows a side that is much more convenient to attach the membrane to than a round shape such as a cable. The cross section itself can be any shape for which a width and a height can be established i.e. any shape that can be circumscribed by a family of rectangles, the ultimate width and height being the width and height of the rectangle with the smallest cross sectional area.

The strip is characterised in that it comprises at least one elongated strength member. However, more preferred is two or more elongated strength members (claim 2). Preferably these strength members are arranged parallel to one another. Even more preferred are five or more elongated strength members arranged parallel to one another. These elongated strength members may have a circular cross section although this is no prerequisite of the invention: oblate cross sections are equally well suited.

The strength member(s) are embedded in a polymer matrix. The type of matrix must be chosen in function of the membrane and/or in function of the application. Most preferred are thermoplastic polymers such as PUR, PVC, polyethylene-tereftalate (PET) that are easy to extrude. Also preferred or fluoropolymers such as ETFE although these are more difficult to extrude. Most preferred is that the polymer used for the impregnation or lamination of the membrane or the foil constituting the membrane is compatible with the polymer of the strip. With compatible is meant that a simple gluing or welding is possible.

The matrix preferably encloses the elongated strength member(s) completely in order to seal them from climatic circumstances.

The strength member must adhere to the polymer matrix in order to form a composite structure. The adhesion can be based on mechanical anchoring of the tensile member in the matrix or on chemical bonding between the surface of the tensile member and the matrix.

The elongated strength members can be made out of steel (claim 3) i.e. steel cords. The steel cords can be strands i.e. an assembly of single steel filaments or they can be cords i.e. an assembly of strands. A non-exhaustive overview of the many possible types can be found in the Bekaert Steelcord catalogue, issue of January 2000, pages 27 to 34. The steel used for the invention preferably has a plain carbon steel composition. Such a steel generally comprises a minimum carbon content of 0.40 wt % C or at least 0.70 wt % C but most preferably at least 0.80 wt % C with a maximum of 1.1 wt % C, a manganese content ranging from 0.10 to 0.90 wt % Mn, the sulphur and phosphorous contents are each preferably kept below 0.03 wt %; additional micro-alloying elements such as chromium (up to 0.2 to 0.4 wt %), boron, cobalt, nickel, vanadium—a non-exhaustive enumeration—may also be added.

Typically the filaments used for the tension members will have a high tensile strength in order to improve the strength over weight ratio of the tension member. Typically the steel wires have a tensile strength of more than 2650 N/mm², or more preferably above 3000 N/mm², or even more preferably above 4000 N/mm² the latter being the highest minimum tensile strength now achievable in the art.

The coating can be any type of metallic coating as is customary in the field such as bare, phosphated, galvanised (electrolytically or hot dip) or brass plated (electrolytically). Non-metallic primer coatings on top of the metallic surface selected from the group of organo functional silanes, organo functional titanates and organo functional zirconates are preferred as they can promote the adhesion between the tensile member and the polymer matrix.

The elongated strength members can be made out of a synthetic high strength fiber (claim 4). Examples of such fibres are the class of aromatic poly amids or ‘aramid’ fibres as they are known in the art i.e. a manufactured fibre in which the fibre-forming material is a long chain synthetic polyamide having at least 85% of its amide linkages —NH—CO—attached directly to two aromatic rings. Various brand names are known such as Kevlar®, Twaron®, Nomex®, to name just a few. Another synthetic high strength fibre is based on oriented polyethylene sometimes called high performance polyethylene and known under the name Dyneema SK60. The synthetic high strength fibres are spun together to form filaments, filaments are twisted together to form ropes. The ropes themselves must again be treated in order to obtain adhesion to the polymer matrix.

As the strips allow for a large interaction surface with the membrane compared to regular steel cables, they spread the load and prevent excessive contact pressures between strength member(s) and membrane. In addition, the elaborate method of making sleeves onto the membrane to guide the cords can be eliminated.

The strips can be attached to the membrane by means of gluing (claim 5). With gluing is meant any way of fixing where a chemical intermediate is used to rigidly attach a first body to a second body. Gluing can be done by means of a hot melt adhesive where the adhesive is preferably from the same family of the membrane and matrix polymer. Or gluing can be done by means of room temperature adhesive systems as e.g. those based on polydimethsiloxanes (‘silicones’), methacrylates or cyanoacrylates without being exhaustive. For all systems a proper pre-treatment is necessary in order to obtain a good bond. Particularly difficult is the bonding of ETFE (known for its extremely low surface-reactivity) where a plasma treatment is preferred to increase the affinity of the surface. Gluing can also be done by a double-sided tape system. This is particularly useful when the membrane polymer is not of the same type as the tension member matrix polymer: one side of the tape Is than adapted to glue to the membrane, while the other side is optimised to glue to the polymer of the tension member.

Another way for connecting the strip to the membrane is the use of welding (claim 6). Welding can either be done by means of high frequency welding or by means of heat-pressure welding. For both ways of welding the thermoplastic properties of both polymers on membrane and tension member are crucial. Most preferable here is that both polymers are at least of the same family of polymers. The blending of the matrix material is a possibility to ease the welding of the tension members to the membrane.

Another way for connecting the strip to the membrane is mechanical fastening (claim 7). Here many ways are possible such as—without being exhaustive—stapling, sewing, stitching, bolting or riveting the strip to the membrane. In order to protect the mechanical fastening, the use of a counter strip to prevent the ripping of the membrane is also possible.

As the strips of the architectural fabric span the whole structure, they can conveniently be used to distribute pressurised gas in an air pocket structure. One or more of the elongated strength members can then be replaced with an air tube. At regular intervals, a distribution hole can be foreseen in order to supply air to the pocket. Such a strip with an integrated air channel can also be used to distribute fresh air inside the infrastructure when it is mounted at the inner side of the membrane. Likewise a string of tiny light bulbs can also be extruded into the strip in combination with the strength member. Of course the polymer matrix then used must be transparent.

### BRIEF DESCRIPTION OF THE DRAWINGS

The invention will now be described into more detail with reference to the accompanying drawings wherein

FIG. 1: Illustrates a suspended architectural fabric according the invention.

FIG. 2: Shows a cross section of the tension member of the architectural fabric according a first embodiment.

FIG. 3: Illustrates a cross section of the tension member of the architectural fabric according a second embodiment

FIG. 4: Illustrates a cross section of the tension member of the architectural fabric according a third embodiment

FIG. 5: Illustrates a cross section of the tension member of the architectural fabric according a fourth embodiment

### DESCRIPTION OF THE PREFERRED EMBODIMENTS OF THE INVENTION

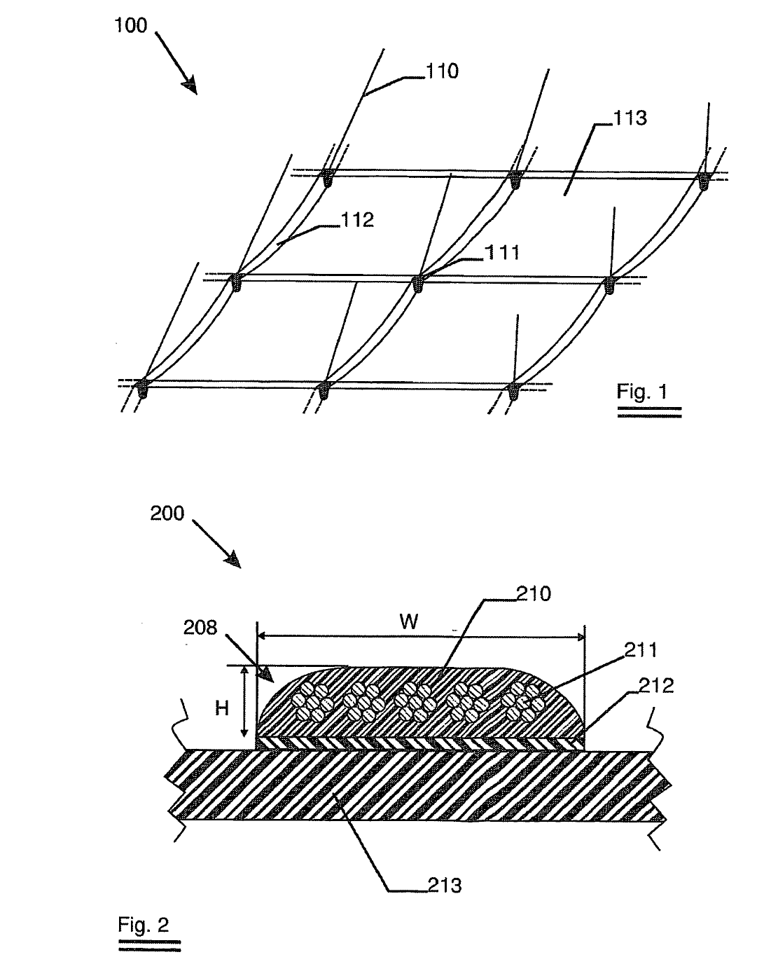

FIG. 1 shows an architectural fabric of the suspended type according the invention. The architectural fabric 100 comprising one membrane 113 and a tension member 112 is shown. At the crossing points the tension members are turnably attached to one another by means of connector 111.

FIG. 2 shows a cross section of an architectural fabric 200 according the invention with a single membrane 213. The tension member 208 comprises steel cords 211 embedded in a polymer matrix 210. As the height H is much less than half of the width W, the tension member thus forms a strip. A double-sided self-adhesive tape 212 is used to intimately connect the strip to the membrane.

Such a strip has been produced by means of extrusion and had the following properties:

TABLE 1

| | |
|---|---|
| Number of cords | 10 |
| Cord type and diameter | 7 × 19/3.2 |
| Coating type | Hot dip galvanised |
| Width × Height of strip | 38 mm × 5 mm |
| Matrix | Polyurethane |
| | Desmopan 8603 |
| Breaking load of strip | 100 406 N |
| (repeated measurement) | 103 171 N |
| Mass per meter | 500 g/m |

For comparison: a standard steel cable 9×21F-IWRC (rope grade 1570 N/mm²) pulling 104 kN will have a diameter of 13 mm and a mass per meter of 723 g/m (‘Pfeifer Drako’ data sheet for DRAKO 300 T, 9 strand steel core rope for traction drive elevator). As a double-sided self-adhesive tape 212, TESA nr. 05686-00018 was used.

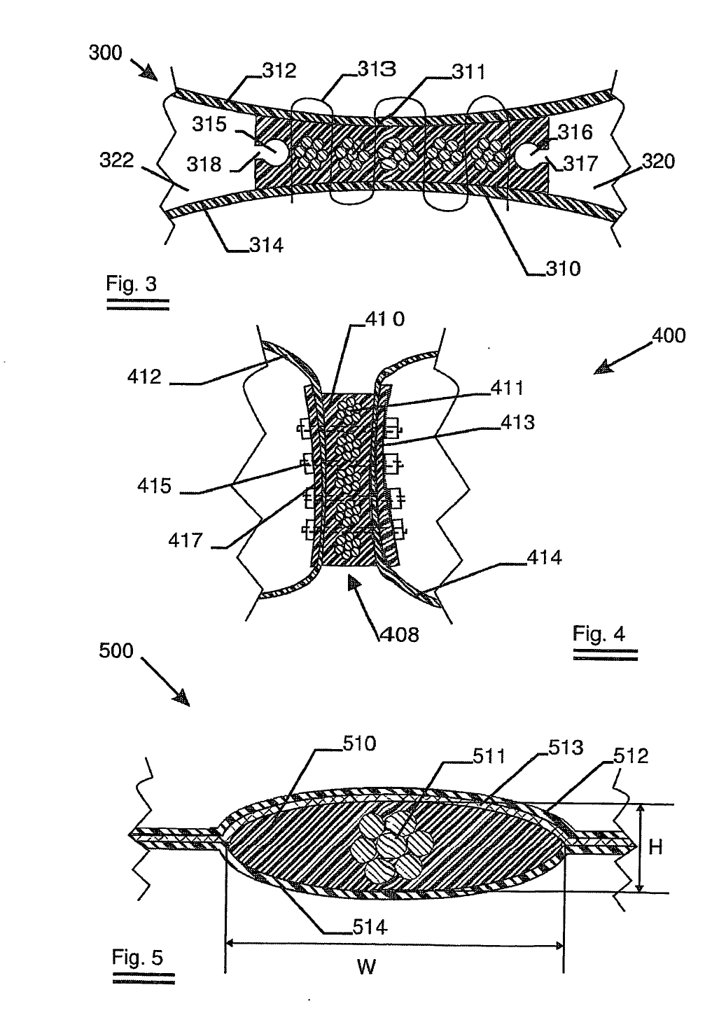

FIG. 3 shows a second preferred embodiment of the invention. It can be used for the air-pocket type architectural fabrics. Here both sides with width W of the strip are used to hold two membranes 312 and 314. The tensile member comprises five cords 311 embedded in a matrix 310. The cross section has a slightly concave shape in order to accommodate for the bending of the membrane. Air channels 315 and 316 on both sides are foreseen to allow pressurised air to enter the air pockets 322 and 320 through the vias 317 and 318. The channels 315 and 316 are obtained by replacing a steel cord by a tube during the extrusion. A supplementary fixing—in addition to welding—of the membrane to the strip is achieved by stitching a wire 313 up and down through first membrane 312 through matrix 310 through second membrane 314 and back thereby each time wrapping a steel cord 311. The wire 313 can be any wire suitable for the purpose but is preferentially made of a high-tenacity manmade fibre such as an aramid or nylon. Care must be taken not to damage the steel cord since this could lead to water ingress and subsequent corrosion of the steel. Also the air channels 315 and 316 must not be pierced in order not to loose pressure. The person skilled in the art will readily appreciate that such a strip as described in FIG. 3 can also be used to distribute fresh air under the membrane when the strip is mounted at the inside of the membrane.

FIG. 4 shows a third preferred embodiment for use in an architectural fabric comprising air tunnels parallel to one another. The fabric comprises large ETFE extruded sleeves 412 and 414 connected to one another through tension member 408. The tension member comprises a matrix 410 and five aramid cords 411. The membranes 412 and 414 are mechanically fixed to tension member 408 by means of rivets 415 and ant-rip strips 417 and 413. In addition the mounting of the strip with the wider side parallel to the gravitational force direction enhances the stiffness of the architectural fabric in the vertical direction, while remaining flexible in the horizontal direction.

FIG. 5 shows a fourth embodiment of the invention where the tension member is integrated into the membrane. A single steel cord 511 is extruded into a matrix 510. Again the width W of the tension member is substantially larger than its height H. The tension member is then heat welded onto the base fabric 513. Thereafter the protection 512 is laminated onto the fabric from both sides, thus fully enclosing the tensile member.

1. An architectural fabric for covering an infrastructure comprising a grid and at least one membrane, said grid for carrying said at least one membrane, said grid having a pattern suitable to cover said infrastructure, said grid comprising strips having a cross section with a height and a width, said height being less than half of said width for easy fastening of said strips to said membrane characterised in that said strip comprises at least one elongated strength member and a polymer matrix adhering to said at least one elongated strength member.

2. The architectural fabric according to claim 1, wherein said strip comprises at least two elongated strength members and a polymer matrix adhering to said at least two elongated strength members.

3. The architectural fabric according to claim 1, wherein said elongated strength members are steel cords.

4. The architectural fabric according to claim 1, wherein said elongated strength members are synthetic high strength fibre cords.

5. The architectural fabric according to claim 1, wherein said strip member is glued to said membrane.

6. The architectural fabric according to claim 1, wherein said strip is welded to said membrane.

7. The architectural fabric according to claim 6, wherein said strip is stapled or sewn or stitched or bolted or riveted to said membrane.

8. The architectural fabric according to claim 1, wherein said strip further comprises at least one air channel with regularly spaced outlets.

9. The architectural fabric according to claim 1, wherein said strip further comprises at least one string of tiny light bulbs.
